(19) United States
(12) Patent Application Publication
(10) Pub. No.: US 2008/0163935 A1
(43) Pub. Date: Jul. 10, 2008

(54) Auxiliary Water Supply for a Building

(76) Inventor: Corey Bossuyt, Fort Whyte (CA)

Correspondence Address: ADE & COMPANY INC., 2157 Henderson Highway, WINNIPEG, MB, R2G1P9, omitted

(21) Appl. No.: 11/969,419

(22) Filed: Jan. 4, 2008

(30) Foreign Application Priority Data
Jan. 10, 2007 (CA) 2574075

(51) Int. Cl. E03B 11/02; F17D 1/14; F17D 3/00; E03B 1/04; E03C 1/02

(52) U.S. Cl. 137/358; 137/565.01

(57) ABSTRACT

Auxiliary water is supplied to a building, which also receives water from a main supply line, from an external portable tank separate from the main supply line. The water is pumped from the tank through an auxiliary supply line to a junction with the main supply line. One-way valves are provided in both the main supply line and the auxiliary supply line before the junction to prevent backflow in each of the supply lines from the other supply line. Water is pumped to the auxiliary supply line at a prescribed pressure which is less than the main supply line pressure so that the valves allow water to be drawn only from the main supply line until a loss of main line pressure at which point the valves automatically cause the greater auxiliary supply line pressure to cause water to be drawn only from the auxiliary supply line.

This application claims foreign priority benefits from Canadian Patent Application 2,574,075 filed Jan. 10, 2007.

### FIELD OF THE INVENTION

The present invention relates to a system and a method for supplying auxiliary water from an auxiliary source to a building receiving water from a main supply. The system is particularly useful when water from the main supply is unsuitable, for example due to loss of pressure or contamination thereof.

### BACKGROUND

Loss of water pressure or water contamination to an incoming water supply in a building is a known occurrence, for example due to water main breaks when supplied by public utilities, or for example by a possible contamination or pump failure when supplied by a well. Many businesses and homes however are very dependent on a single water source, for example either public utility lines or wells, as an only source of water for the building.

Some attempts have been made to provide an emergency supply of water in the event that a building ceases to receive ongoing supply from its regular source. Some of the prior art attempts are described in Canadian patent 2,012,452 belonging to Fenwick and U.S. Pat. Nos. 6,971,399 belonging to Cowan, 5,778,471 belonging to Collison and 4,718,452 belonging to Maitland. In each instance, a tank is generally provided in series with the main supply line so that the tank is continually replenished with fresh water while the building draws from the tank to maintain an extra reserve of water which is fresh in the tank so that in the event that water can no longer be drawn from the main source, water can instead be depleted from the reserve tank. Once the reserve tank is depleted however there is generally no means provided to replenish the tank or provide additional water from an auxiliary source. Prior art attempts have accordingly have a very limited capacity and a limited flexibility in its applications.

### SUMMARY OF THE INVENTION

According to one aspect of the invention there is provided an auxiliary water supply system for a building including a main supply line arranged to supply the building with water, the system comprising:

an auxiliary supply line arranged to supply the building with water from an auxiliary water source; and

a controller arranged to select water being supplied from the auxiliary supply line and the main supply line.

According to a second aspect of the present invention there is provided an auxiliary water supply system in a building in combination with a portable tank having a pump arranged for pumping water from the portable tank, the system comprising:

a main supply line arranged to supply the building with water from a public utility;

an auxiliary connector supported externally on the building and arranged for connection to the pump of the portable tank;

an auxiliary junction connected in series with the main supply line;

an auxiliary supply line in communication between the auxiliary connector and the auxiliary junction;

a main one-way valve connected in series with the main supply line between the public utility and the auxiliary junction and arranged to prevent flow from the auxiliary junction to the public utility;

an auxiliary one-way valve connected in series with the auxiliary supply line between the auxiliary connector and the auxiliary junction and arranged to prevent flow from the auxiliary junction to the auxiliary connector;

a drain junction coupled in series with the auxiliary supply line;

a drain line arranged to connect the drain junction to a sewer; and

a shut-off valve in series with the drain line.

According to a further aspect of the present invention there is provided a method of supplying auxiliary water to a building having a main supply line arranged to supply the building with water from a main source, the method comprising:

providing an auxiliary water source separate from the main source;

connecting an auxiliary supply line between the auxiliary water source and the building in parallel with the main supply line; and

preventing water being supplied through the main supply line from the main source when supplying water from the auxiliary water source through the auxiliary supply line.

By providing an auxiliary water source which is separate from a main source to a building, the auxiliary source can be readily replenished even if the main source is shutoff for an extended period of time. By providing a controller which permits selecting between the main supply line and the auxiliary supply line, cross contamination between the two separate supplies can be prevented.

The auxiliary water source preferably comprises a tank supported externally from the building and which is separate from the main supply line. The auxiliary water source may comprise a portable tank and a pump supplying the auxiliary supply line with a flow of water under pressure.

The controller may comprise valves arranged to be supported in the auxiliary supply line and in the main supply line, which are arranged to open the supply line having the greatest pressure.

The controller preferably includes a one-way valve arranged to be supported in series with the main supply line to prevent backflow from the auxiliary supply line to the main supply line and a one-way valve arranged to be supported in series with the auxiliary supply line to prevent backflow from the main supply line to the auxiliary supply line.

There may also be provided a drain line coupled to the auxiliary supply line and a shut-off valve in series with the drain line. When the controller includes a one-way valve arranged to be supported in series with the auxiliary supply line, the drain line is preferably coupled to the auxiliary supply line between the one-way valve and the auxiliary water source. The auxiliary supply line is preferably drained when supplying water to the building through the main supply line.

The auxiliary supply line is preferably coupled to the auxiliary water source through an external connection supported externally on the building.

The external connection may be supported within a housing having a lock arranged to restrict access to the external connection by unauthorized persons.

There may also be provided an electrical supply socket supported externally on the building commonly in the housing with the external connection for the auxiliary supply line. The electrical supply socket and the external connection for the auxiliary supply line may alternatively be provided in separate housings, each with respective locks thereon to prevent access by unauthorized persons. Accordingly, the electrical supply socket and the external connection for the auxiliary supply line can be located relative to one another as desired to accommodate any building codes or regulations which may be relevant to a particular installation.

The method of supplying auxiliary water includes providing a portable tank, locating the portable tank externally from the building, and pumping water from the portable tank to the auxiliary supply line from an external pump supported on a trailer frame with the portable tank.

Water is preferably supplied to the building through the auxiliary supply line when water pressure in the main supply line falls below water pressure in the auxiliary supply line and is preferably supplied to the building through the main supply line when water pressure in the auxiliary supply line falls below water pressure in the main supply line.

One embodiment of the invention will now be described in conjunction with the accompanying drawings in which:

### BRIEF DESCRIPTION OF THE DRAWINGS

FIG. 1 is an overall schematic diagram of the system.

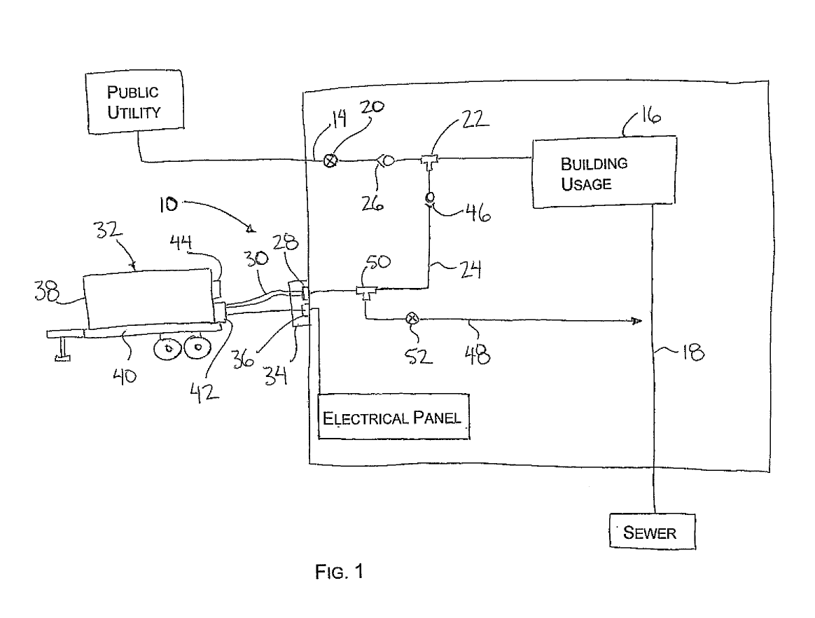

FIG. 2 is a perspective view of the components of the system which are installed within a building.

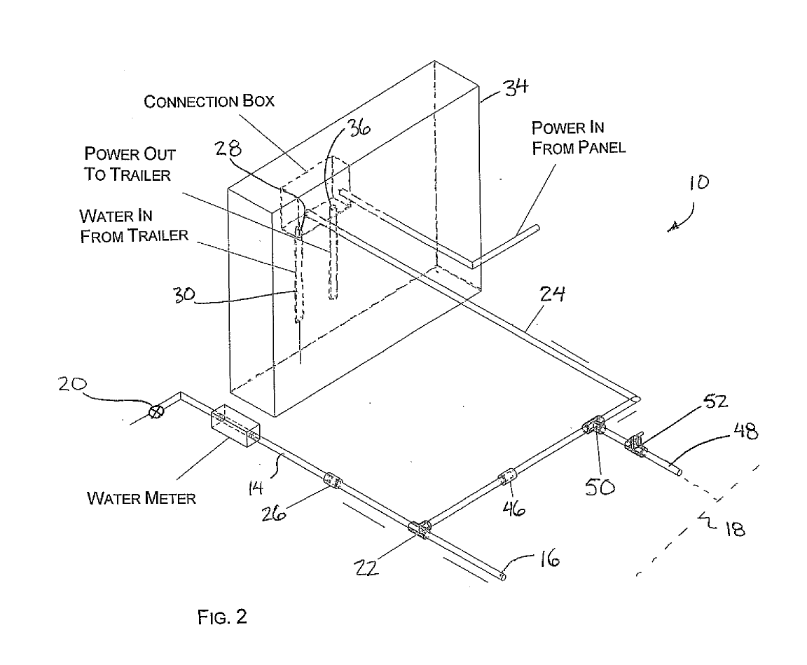

FIG. 3 is a perspective view of a portable tank for use as the auxiliary source for connection to the components of the system installed within a building.

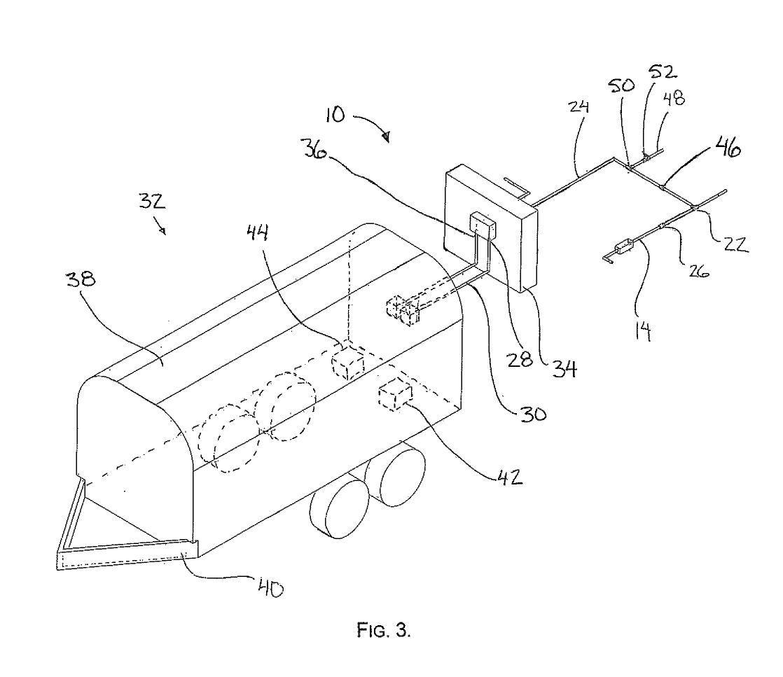

In the drawings like characters of reference indicate corresponding parts in the different figures.

### DETAILED DESCRIPTION

Referring to the accompanying figures there is illustrated an auxiliary water supply system generally indicated by reference numeral 10. The system 10 is particularly suited for supplying a building which is generally already equipped with a main water supply line 14 coming from a public utility main or a well for example. The main supply line 14 is typically fed directly to various water consuming devices and water dispensing areas within the building generally indicated as a consumption area 16. Used water from the consumption area 16 is dispensed from the building along a suitable sewer line 18.

The main supply line includes a shutoff valve 20 adjacent a meter as the main supply line enters the building as in a conventional connection to a public utility system. An auxiliary junction 22 is coupled in series with the main supply line in series between the shutoff valve 20 entering the building and the consumption area 16. The auxiliary junction 22 permits an auxiliary supply line 24 to be joined with the main supply line prior to the incoming supply of water reaching the usage area or consumption area 16.

A main one way valve 26 is also coupled in series with the main supply line 14 upstream from the auxiliary junction 22 and downstream from the shutoff valve 20 so as to be located in series between the auxiliary junction 22 and the main water supply source. The auxiliary junction 22 is accordingly located between the main one way valve 26 and the consumption area with the main one way valve 26 being arranged to prevent flow from the junction area back to the main source. The one way valve 26 comprises a suitable check valve or back flow preventer as required by the appropriate jurisdiction to prevent cross contamination between two different water supplies.

The auxiliary supply line 24 extends between an external connector 28 at the exterior of the building and the auxiliary junction 22. The external connector comprises a connector which permits flow lines 30 to be selectively coupled thereto for connection between the building and an external auxiliary source of water 32. The external connector 28 is mounted within a suitable housing 34 mounted on the exterior wall of the building so as to be accessible through a suitable cover on the housing 34 which includes a lock thereon to prevent access by unauthorized persons. Also within the housing, an electrical supply socket 36 is common supported on the exterior of the building for use as required by the auxiliary water source 32.

The auxiliary water source 32 generally comprises a tank 38 portably supported on a trailer frame 40 to be towed on site and parked adjacent the building when an auxiliary water source is required. The source 32 also includes a pump 42 supported on the trailer frame 40 with the tank 38 to receive water from the tank 38 and pump the water through the flow lines 30 into the external connector 28 on the building and subsequently through the auxiliary supply line 24 into the building. The pump 42 is arranged to provide sufficient water pressure that in the absence of the main water supply, sufficient pressure can be generated in a flow through the auxiliary supply line 24 from the auxiliary source 32 so as to provide basic water services within the building.

The auxiliary water source 32 further includes a heater 44 for providing heat to the tank and the flow lines 30 to prevent freezing in colder climates. The heater 44 and the pump 42 can both be driven electrically by connection to the electrical supply socket 36 on the building. By locating the electrical supply socket 36 commonly within the housing 34 with the external connector 28 of the auxiliary supply line 24, the electrical connections between the auxiliary water source 32 and the building can also be locked and access thereof restricted by unauthorized persons.

An auxiliary one way valve 46 is connected in series with the auxiliary supply line in series between the external connector 28 and the auxiliary junction 22. Accordingly the one way valve 46 is located upstream from the auxiliary junction 22 and downstream from the external connector 28 relative to the flow direction through the auxiliary supply from the source 32 to the consumption area 16. The auxiliary one way valve 46 is a suitable check valve or backflow preventer which is accordingly arranged to prevent a backflow of fluid from the auxiliary junction 22 back to the auxiliary water source 32 also for preventing cross contamination between the two different water sources.

A drain line 48 is provided for communicating the auxiliary supply line 24 with the sewer line 18 of the building or another suitable drain area. A drain junction 50 is provided in series with the auxiliary supply line 24 between the auxiliary one way valve 46 and the external connector connected to the auxiliary source 32. The drain junction 50 is thus located upstream from the auxiliary one way valve 46 and downstream from the external connector to the source so as to allow draining of the auxiliary supply line 24 while preventing the main supply line from being drained to the drain line 48 by action of the auxiliary one way valve 46. The connection of the drain line 48 to the sewer line 18 includes an air gap therebetween so as not to form a sealed connection, but rather to be suitably arranged to prevent backflow of the sewer into the drain line 48. A suitable valve which prevents backflow may also be used for connecting the drain line 48 to the sewer line 18.

A shutoff valve 52 is coupled in series with the drain line between the drain junction 50 and the sewer line 18 to selectively prevent draining of the auxiliary supply line 24 when the shutoff valve 52 is closed. It is desirable to make use of the auxiliary supply system 10 whenever there is a loss of pressure from the main supply or if the main supply is shutoff due to a concern for contamination for example.

Prior to use of the system 10 the pressure coming from the main supply line allows the valves to passively and automatically allow the pressurized flow to flow through the main one way valve 26 from the main supply to the building usage area. At the same time the pressure flow is prevented from back flowing past the auxiliary one way valve 46 to prevent the main supply from feeding water into the auxiliary supply.

Under normal use conditions where water is drawn from the main source, the shutoff valve 52 of the drain line is left open so that no pressured flow or liquid is permitted to accumulate within the auxiliary supply line 24, but rather the auxiliary supply line is drained through the drain line 48 to the sewer or other suitable drain area. Leaving the drain shutoff valve 52 open prevents freezing fluids within the auxiliary supply or near the external connector 28 on the external side of the building and thereby prevents related damage. Furthermore in event that unauthorized persons attempt to force undesirable fluids into the auxiliary supply line from the external connector 28, any such fluids injected into the auxiliary supply line would readily be drained through the drain line to the sewer rather than being forced into the main supply line.

When a problem occurs, that is a loss of pressure or the main line being shutoff, the auxiliary source 32 is first brought to a location adjacent the building so that the flow lines 30 can be connected from the auxiliary source 32 to the external connector 28 of the auxiliary supply line. In addition suitable electrical connections are made between the heater 44 and/or pump 42 of the tank to the electrical supply socket 36 also on the exterior of the building. The drain shutoff valve 52 is then closed and the pump is operated to maintain water pressure within the auxiliary supply line which meets a prescribed operating pressure of the pump which is sufficient to meet basic operating demands for operating basic serves within the building while being less than the normal operating pressure in the main line from the public utility.

Once again, the one way valves passively and automatically cause the pressured flow in the auxiliary supply line to flow through the auxiliary one way valve 46 while the main one way valve 26 prevents back flow into the main supply line so that the building consumption area 16 is feed water in this instance from the auxiliary water source 32. The tank 38 can be refilled on an ongoing basis as required.

When use of the auxiliary source 32 is no longer required, the pump is turned off, and the drain shutoff valve 52 is opened to drain the auxiliary supply line from remaining liquid. The flow lines 30 along with electrical connections to the electrical supply socket 36 are also disconnected so that the auxiliary source on the trailer frame 40 can be towed away to a remote location away from the building. Opening the shutoff valve on the main supply line or pressure being resumed in the main supply will again cause flow to return from the main supply source rather than the auxiliary source without any concern for cross contamination in the mean time.

In this arrangement the one way valves 26 and 46 act as a suitable controller which passively and automatically redirects flow from the source of greatest pressure to the consumption area 16, while preventing back flow to the other source. The shutoff valves for the drain line and the main supply line along with the supply pressure provided by the pump on the auxiliary source 32 also serve to assist the system in controlling where the water is supplied from to the consumption area.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An auxiliary water supply system for a building including a main supply line arranged to supply the building with water, the system comprising:
an auxiliary supply line arranged to supply the building with water from an auxiliary water source; and
a controller arranged to select water being supplied from the auxiliary supply line and the main supply line.

2. The system according to claim 1 wherein the auxiliary water source comprises a tank supported externally from the building.

3. The system according to claim 1 wherein the auxiliary water source is separate from the main supply line.

4. The system according to claim 1 in combination with a portable tank and a pump supplying the auxiliary supply line with a flow of water under pressure and being supported externally from the building.

5. The system according to claim 1 wherein the controller comprises valves arranged to be supported in the auxiliary supply line and in the main supply line, the valves being arranged to open the supply line having a greatest pressure.

6. The system according to claim 1 wherein the controller includes a one-way valve arranged to be supported in series with the main supply line to prevent backflow from the auxiliary supply line to the main supply line.

7. The system according to claim 1 wherein the controller includes a one-way valve arranged to be supported in series with the auxiliary supply line to prevent backflow from the main supply line to the auxiliary supply line.

8. The system according to claim 1 wherein there is provided a drain line coupled to the auxiliary supply line and a shut-off valve in series with the drain line.

9. The system according to claim 8 wherein the controller includes a one-way valve arranged to be supported in series with the auxiliary supply line to prevent backflow from the main supply line to the auxiliary supply line and wherein the drain line is coupled to the auxiliary supply line between the one-way valve and the auxiliary water source.

10. The system according to claim 1 wherein the auxiliary supply line is coupled to the auxiliary water source through an external connection supported externally on the building.

11. The system according to claim 10 wherein the external connection is supported within a housing having a lock arranged to restrict access to the external connection by unauthorized persons.

12. The system according to claim 10 wherein there is provided an electrical supply socket supported externally on the building, the external connection and the electrical supply socket being located within a common housing.

13. An auxiliary water supply system in a building in combination with a portable tank having a pump arranged for pumping water from the portable tank, the system comprising:
a main supply line arranged to supply the building with water from a public utility;
an auxiliary connector supported externally on the building and arranged for connection to the pump of the portable tank;
an auxiliary junction connected in series with the main supply line;
an auxiliary supply line in communication between the auxiliary connector and the auxiliary junction;
a main one-way valve connected in series with the main supply line between the public utility and the auxiliary junction and arranged to prevent flow from the auxiliary junction to the public utility;
an auxiliary one-way valve connected in series with the auxiliary supply line between the auxiliary connector and the auxiliary junction and arranged to prevent flow from the auxiliary junction to the auxiliary connector;
a drain junction coupled in series with the auxiliary supply line;
a drain line arranged to connect the drain junction to a sewer; and
a shut-off valve in series with the drain line.

14. A method of supplying auxiliary water to a building having a main supply line arranged to supply the building with water from a main source, the method comprising:
providing an auxiliary water source separate from the main source;
connecting an auxiliary supply line between the auxiliary water source and the building in parallel with the main supply line; and
preventing water being supplied through the main supply line from the main source when supplying water to the building from the auxiliary water source through the auxiliary supply line.

15. The method according to claim 14 including providing an auxiliary water source comprising a portable tank, locating the portable tank externally from the building, and pumping water from the portable tank to the auxiliary supply line.

16. The method according to claim 14 including supplying water to the building through the auxiliary supply line when water pressure in the main supply line falls below water pressure in the auxiliary supply line.

17. The method according to claim 14 including supplying water to the building through the main supply line when water pressure in the auxiliary supply line falls below water pressure in the main supply line.

18. The method according to claim 14 including preventing backflow in the auxiliary supply line from the main supply line.

19. The method according to claim 14 including preventing backflow in the main supply line from the auxiliary supply line.

20. The method according to claim 14 including draining the auxiliary supply line when supplying water to the building through the main supply line.
